(19) United States
(12) Patent Application Publication
(10) Pub. No.: US 2006/0148416 A1
(43) Pub. Date: Jul. 6, 2006

(54) Semiconductor integrated circuit device and wireless communication system

(76) Inventors: Yoshiaki Harasawa, Maebashi (JP); Masumi Kasahara, Takasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/324,277

(22) Filed: Jan. 4, 2006

(30) Foreign Application Priority Data
Jan. 5, 2005 (JP) 2005-000585

(51) Int. Cl. H04B 1/00

(52) U.S. Cl. 455/71

(57) ABSTRACT

The present invention supplies a stable power supply voltage from small output currents to large output currents, regardless of operation states of a semiconductor integrated circuit device. When an output current of the regulator is small (idle mode), all switches go off. Thereby, power is supplied to a transistor via resistors, a load of a transistor becomes large, and current consumption of the regulator can be reduced. Since a transistor goes off, parasitic capacitance can be reduced, and a sufficient phase margin can be ensured between output of a differential voltage comparator and an output signal of the regulator. In normal operation, all the switches go on, load resistance is reduced to reduce noise, and driving capability is improved to supply stable power supply voltages.

### CROSS-REFERENCE TO RELATED APPLICATION

The present application claims priority from Japanese patent application No. 2005-000585 filed on Jan. 5, 2005, the content of which is hereby incorporated by reference into this application.

### BACKGROUND OF THE INVENTION

The present invention relates to technology for supplying a power supply voltage in a semiconductor integrated circuit device, and more particularly to technology useful for stable supply of an internal power supply voltage in a semiconductor integrated circuit device for radio frequency processing.

In recent years, cellular phones have come into wide use, and have been demanded to have various functions. In such cellular phones, generally, two semiconductor integrated circuit devices, one for RF (radio frequency) processing and the other for baseband processing, are used.

A semiconductor integrated circuit device for RF processing converts a received signal into a baseband signal as a so-called I or Q signal. The semiconductor integrated circuit device for RF processing is provided with a regulator that supplies power supply voltage to a receiving block and a transmitting block, a regulator that supplies power supply voltage to their VCO (oscillator) circuits of RF (radio frequency), TX (transmission), and IF (intermediate frequency), and a regulator that supplies power supply voltage to a front-end module connected to the outside of the semiconductor integrated circuit device for RF processing.

The regulators compare an output voltage with a reference voltage generated by a band gap circuit by a differential voltage comparator, and control the output voltage to a desired power supply voltage.

An output unit of the differential voltage comparator is provided with two stages of amplifiers (MOS transistors) to reduce output impedance, so that high gain is obtained through the amplifiers.

### SUMMARY OF THE INVENTION

It was found out by the inventors that the regulators provided in the above-described semiconductor integrated circuit device have the following problem.

A semiconductor integrated circuit device for RF processing is provided with a temperature sensor circuit that detects temperature in the semiconductor integrated circuit devices for RF processing. The temperature sensor circuit operates even when the semiconductor integrated circuit device for RF processing is in idle mode.

The regulators increase driving capability by using large-sized transistors of amplifiers to supply a sufficient power supply voltage when the semiconductor integrated circuit device for RF processing is operating normally. As a result, the parasitic capacitance of the amplifiers becomes large.

When a small current consumed by the temperature sensor flows through a final-stage amplifier in the regulators, a delay of a signal outputted from the amplifier becomes large because of the parasitic capacitance. As a result, there may be no phase margin between an output signal of the amplifier fed back to the differential voltage comparator and output of the differential voltage comparator that controls the amplifier.

Problematically, the lack of phase margin causes the regulator to oscillate, resulting in malfunction and element destruction of the regulator.

An object of the present invention is to provide technology for supplying a stable power supply voltage from small output currents to large output currents, regardless of operation states of a semiconductor integrated circuit device.

The aforementioned and other objects of the invention and the novel features thereof will become apparent from the descriptions and accompanying drawings of this specification.

The typical disclosures of the invention will be described in brief as follows.

The present invention comprises: a receiving block; a transmitting block; and a first power supply unit that supplies a power supply voltage to the receiving block and the transmitting block, respectively. The first power supply unit includes a load element control unit that makes load resistance of the first power supply unit higher than when the receiving block and the transmitting block are operating normally, in idle mode in which functions of the receiving block and the transmitting block are inactive.

The present invention comprises an oscillator block comprising circuits common to a receiving block and a transmitting block, and a second power supply unit that supplies a power supply voltage to the oscillator block. The second power supply unit includes a load element control unit that makes load resistance of the second power supply unit higher than when the receiving block and the transmitting block are operating normally, in idle mode in which functions of the receiving block and the transmitting block are inactive.

Other inventions of this application will be described in brief.

The present invention is a wireless communication system including a semiconductor integrated circuit device for radio frequency processing that demodulates a receive signal and modulates a transmission signal. The semiconductor integrated circuit device comprises: a receiving block; a transmitting block; and a first power supply unit that supplies a power supply voltage to the receiving block and the transmitting block, respectively. The first power supply unit includes a load element control unit that makes load resistance of the first power supply unit higher than when the receiving block and the transmitting block are operating normally, in idle mode in which functions of the receiving block and the transmitting block are inactive.

The typical disclosures of the invention will be described in brief as follows.

(1) Regardless of a considerable change in output currents, a phase margin can be ensured between output of a differential voltage comparator and an output signal of a regulator. As a result, the regulator can be prevented from oscillating abnormally, so that stable power supply voltages can be supplied.

(2) The semiconductor integrated circuit device allows power supply units to consume a small amount of power in idle mode.

(3) For the reasons described in (1) and (2) above, low power consumption can be achieved with an improvement in the reliability of the semiconductor integrated circuit device.

(4) Furthermore, by using the semiconductor integrated circuit to form a wireless communication system, low power consumption can be achieved with an improvement in the performance of the wireless communication system.

### BRIEF DESCRIPTION OF THE DRAWINGS

FIG. 1 is a block diagram of a semiconductor integrated circuit device for RF processing according to one embodiment of the present invention;

FIG. 2 is a circuit diagram showing an example of a regulator provided in the semiconductor integrated circuit device for RF processing of FIG. 1;

FIG. 3 is a circuit diagram showing another examples of a regulator provided in the semiconductor integrated circuit device for RF processing of FIG. 1;

FIG. 4 is a drawing for describing the operation of the regulator in FIG. 2;

FIG. 5 is a drawing showing an example of an open loop gain characteristic in the regulator of FIG. 2; and

FIG. 6 is a drawing for describing the operation of the regulator in FIG. 2.

### DETAILED DESCRIPTION OF THE PREFERRED EMBODIMENTS

Hereinafter, embodiments of the present invention will be described with reference to the accompanying drawings. In all drawings for describing the embodiments, in principle, identical members are identified by identical reference numbers and duplicate descriptions of them are omitted.

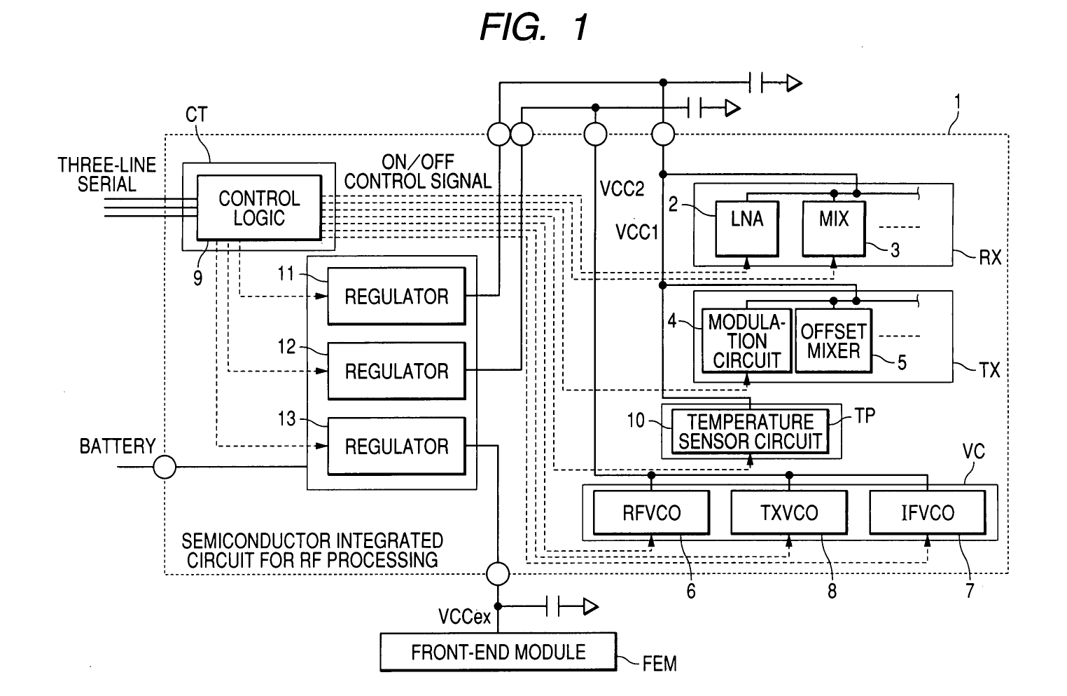

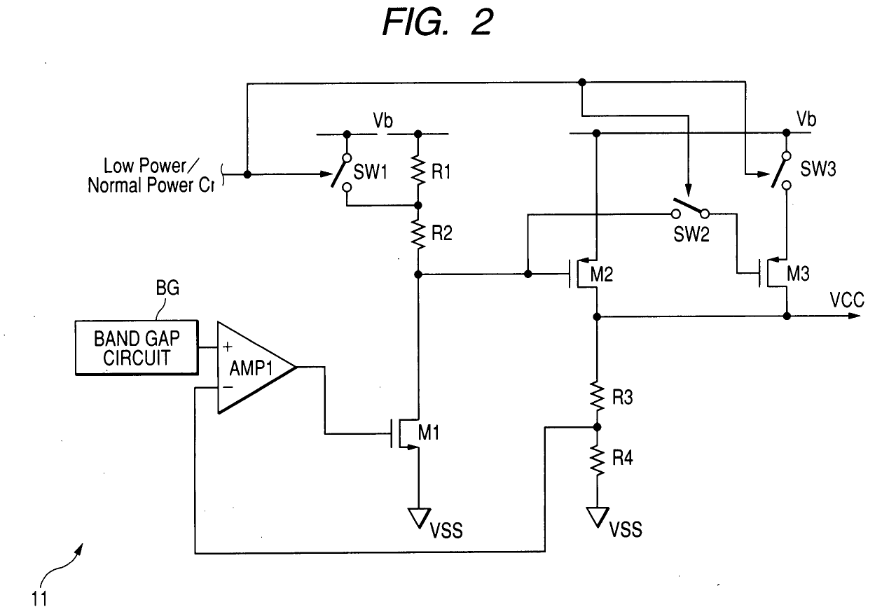

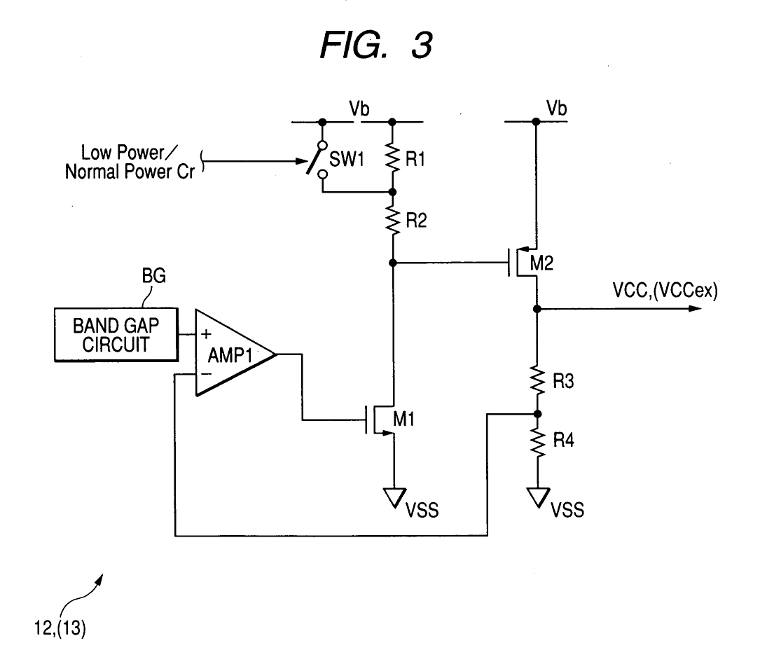

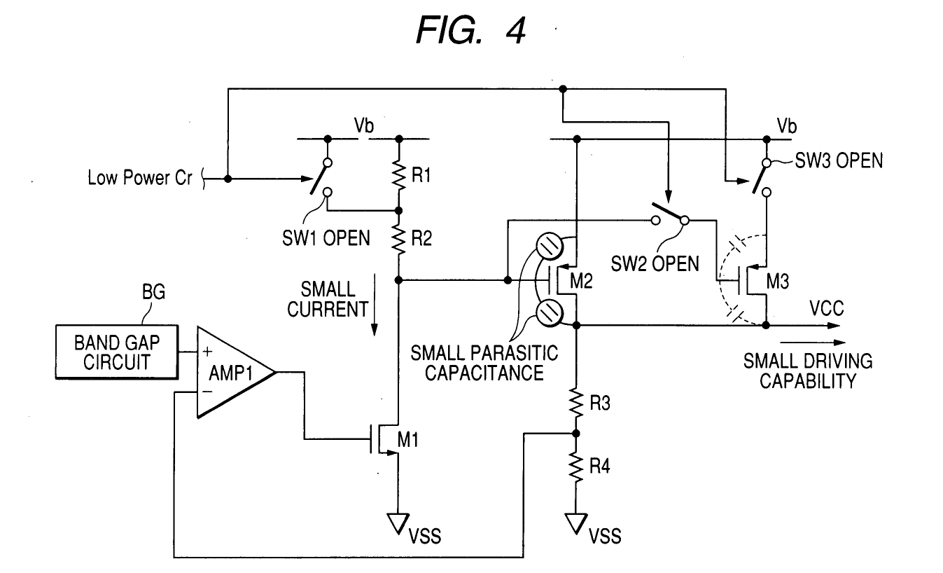

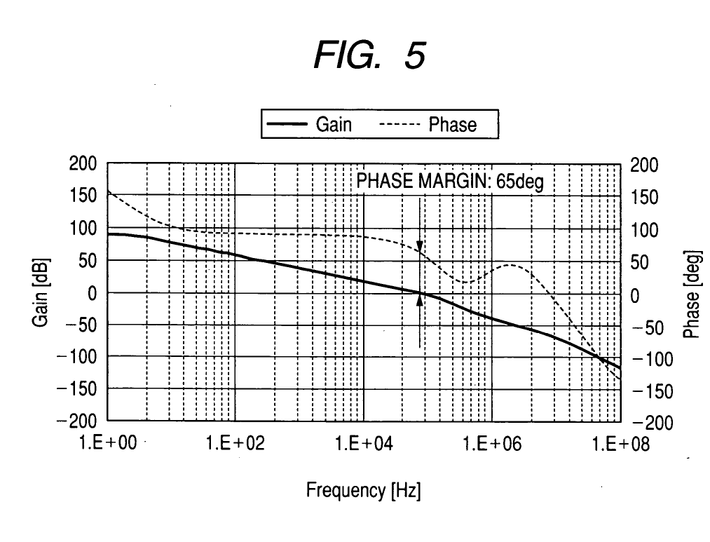

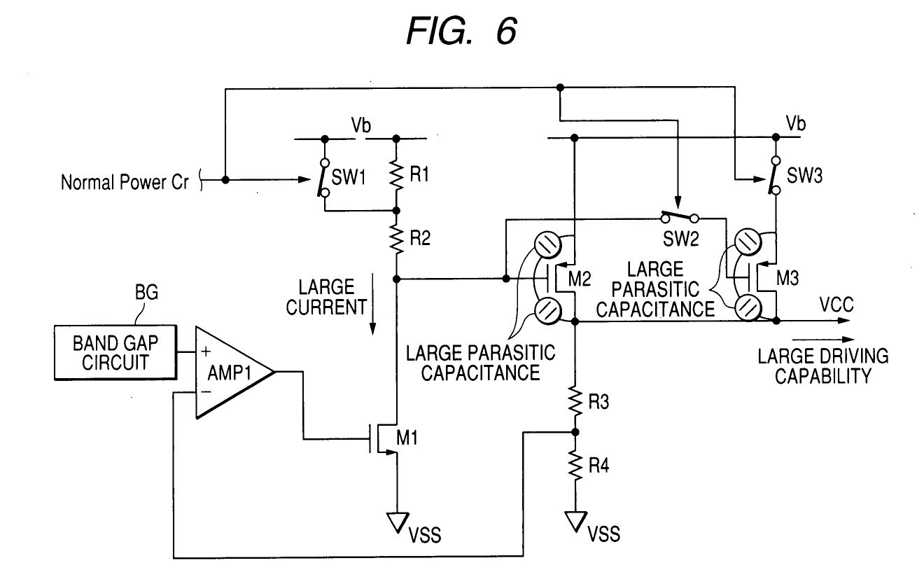

FIG. 1 is a block diagram of a semiconductor integrated circuit device for RF processing according to one embodiment of the present invention. FIG. 2 is a circuit diagram showing an example of a regulator provided in the semiconductor integrated circuit device for RF processing of FIG. 1. FIG. 3 is a circuit diagram showing another examples of a regulator provided in the semiconductor integrated circuit device for RF processing of FIG. 1. FIG. 4 is a drawing for describing the operation of the regulator in FIG. 2. FIG. 5 is a drawing showing an example of an open loop gain characteristic in the regulator of FIG. 2. FIG. 6 is a drawing for describing the operation of the regulator in FIG. 2.

In the present embodiment, a semiconductor integrated circuit device 1 for RF processing (semiconductor integrated circuit) is used in, for example, a wireless communication system such as cellular phones. The semiconductor integrated circuit device 1 for RF processing, as shown in FIG. 1, comprises a receiving circuit (receiving block) RX, a transmitting circuit (transmitting block) TX, a temperature sensor circuit TP, a VCO circuit (oscillator) VC, and a control circuit (transmitting/receiving block) CT comprising circuits common to a transmitting/receiving system such as other control circuits and a clock circuit.

The receiving circuit RX comprises a low noise amplifier (LNA) 2, a mixer circuit (MIX) 3, a phase frequency divider circuit, a high-gain amplification unit, and an offset cancel circuit which are not shown in the drawing.

The low noise amplifier 2 amplifies a receive signal. The mixer circuit 3 is a demodulation circuit that performs demodulation by synthesizing a receive signal amplified by the low noise amplifier 2 with an orthogonal signal frequency-divided by the phase frequency divider circuit.

The phase frequency divider circuit frequency-divides an oscillation signal generated in a radio frequency oscillation circuit 6 to generate orthogonal signals that are 90° out of phase with each other. The high-gain amplification unit amplifies demodulated I and Q signals and outputs them to a baseband circuit of a subsequent stage. The offset cancel circuit cancels input DC offset of amplifiers within the high-gain amplification unit.

The transmitting circuit TX comprises a modulation circuit 4, an offset mixer 5, a frequency divider circuit, a phase frequency divider circuit, an adder, an analog phase comparator, the digital phase comparator, and a loop filter.

The modulation circuit 4 modulates generated orthogonal signals by I signal and Q signal supplied from the baseband circuit. The offset mixer 5 synthesizes a feedback signal obtained by extracting a transmission signal outputted from the transmission oscillation circuit 8 by a coupler or the like, and a signal obtained by frequency-dividing an oscillation signal generated in the radio frequency oscillation circuit 6, thereby generating a signal having a frequency corresponding to a difference between their frequencies.

The frequency divider circuit quarters the frequency of the oscillation signal generated in the radio frequency oscillation circuit 6. The phase frequency divider circuit further frequency-divides the signal frequency-divided by the frequency divider circuit, and generates an orthogonal signal that is 90° out of phase with each other. The adder synthesizes modulated signals.

The analog phase comparator and the digital phase comparator compare output of the offset mixer and a signal synthesized by the adder to detect a phase difference. The loop filter generates a voltage corresponding to the output of a phase detection circuit.

The temperature sensor circuit TP comprises a temperature sensor circuit 10. The temperature sensor circuit 10 detects temperature in the semiconductor integrated circuit device 1 for RF processing.

The VCO circuit VC comprises the radio frequency oscillation circuit (RFVCO) 6, an RF synthesizer (not shown in the drawing), an oscillation circuit (IFVCO) 7, an IF synthesizer, and the transmission oscillation circuit (TXVCO) 8.

The radio frequency oscillation circuit 6 generates a radio frequency oscillation signal. The RF synthesizer constitutes a PLL circuit for RF together with the radio frequency oscillation circuit 6. The oscillation circuit 7 generates an intermediate frequency oscillation signal. The IF synthesizer constitutes a PLL circuit for IF together with the oscillation circuit 7.

The transmission oscillation circuit 8 generates a transmission signal of a predetermined frequency. The control system circuit CT comprises a control logic 9. The control logic 9 controls the entire chip.

Regulators 11 to 13 stabilize a power supply voltage Vb externally supplied from a battery or the like to an arbitrary voltage and supplies the stabilized voltage. The regulators 11 to 13 control voltage supply capability, based on a regulator control signal outputted from the control logic 9.

The regulator (first power supply unit) 11 generates a power supply voltage VCC1 to be supplied to the receiving circuit RX, the transmitting circuit TX, and the temperature sensor circuit 10. The regulator (second power supply unit) 12 generates a power supply voltage VCC2 to be supplied to the VCO circuit VC.

The regulator (third power supply unit) 13 supplies a power supply voltage VCCex to a front end module FEM connected to the semiconductor integrated circuit device 1 for RF processing. The front end module FEM comprises, for example, an antenna switch, a radio frequency filter, and a radio frequency power amplification circuit.

The antenna switch switches transmitted and received signals. The radio frequency filter comprises a SAW filter that removes unnecessary waves from the received signal. The radio frequency power amplification circuit amplifies the transmitted signal.

FIG. 2 is a circuit diagram of the regulator 11.

The regulator 11 comprises a band gap circuit BG, a differential amplifier AMP1, transistors M1 to M3, switches SW1 to SW3, and resistors R1 to R4. The transistor M1 comprises an N-channel MOS, and each of the transistors (final-stage output transistors) M2 and M3 comprises a P-channel MOS.

A reference voltage generated by the band gap circuit BG is inputted to a positive input terminal of the differential amplifier AMP1. A gate of the transistor M1 is connected to an output part of the differential amplifier AMP1.

Resistors R1 and R2 (load resistors) are connected in series between one connection point of the transistor M1 and a power supply voltage Vb, and a reference potential VSS is connected to another connection point of the transistor M1.

One connection point of the switch (load element control unit) SW1 is connected to a connection point of the resistors R1 and R2, and a power supply voltage Vb is connected to another connection point of the switch SW1. A gate of the transistor M2 and one connection point of the switch (electrostatic capacity control unit) SW2 are connected to one connection point of the transistor M1.

One connection point of the switch (electrostatic capacity control unit) SW3 is connected to a connection point of the transistor M2, and the resistors R3 and R4 are connected in series between another connection point of the transistor M2 and the reference potential VSS. A negative input terminal of the differential amplifier AMP1 is connected to a connection point of the resistors R3 and R4.

A regulator control signal Cr outputted from the logic control 9 is inputted to the control terminals of the switches SW1 to SW3. The regulator control signal Cr indicates whether the semiconductor integrated circuit device 1 for RF processing is in normal mode (Normal Power) or idle mode (Low Power).

One connection point of the transistor M3 is connected to another connection point of the switch SW3. Another connection point of the switch SW2 is connected to a gate of the transistor M3.

Another connection point of the transistor M2 and another connection point of the resistor R3 are connected to another connection point of the transistor M3. The another connection point of the transistor M3 functions as an output unit of the regulator 11.

Thus, the regulator 11, which comprises three stages of amplifiers, that is, a differential amplifier AMP1, a transistor M1, and transistors M2 and M3, constitutes an operational amplifier of negative feedback, with its output inputted to the negative input terminal of the differential amplifier AMP1.

FIG. 3 is circuit diagram showing the configuration of the regulator 12 (13).

The regulator 12 (13) comprises a band gap circuit BG, a differential amplifier AMP1, transistors M1 and M2, a switch SW1, and resistors R1 to R4. The regulator 12 is different from the regulator 11 in FIG. 2 in that the switches SW2 and SW3, and the transistor M3 are excluded.

Therefore, a regulator control signal Cr outputted from the control logic 9 is inputted only to the switch SW1, and another connection point of the transistor M2 functions as an output part of the regulator 12 (13). Other connections are the same as those of the regulator 11 and a duplicate description of them is omitted.

The following describes the operation of the regulator 11 (to 13) in the present embodiment.

With reference to FIG. 4, a description will be made of the operation of the regulator 11 when the semiconductor integrated circuit device 1 for RF processing is in idle mode (Low Power).

When the semiconductor integrated circuit device 1 for RF processing is in idle mode, functional blocks other than the temperature sensor circuit 10 are in stop states, and an output current is small.

At this time, the regulator control signal Cr turns into Lo signal, and as shown in the drawing, all of the switches SW1 to SW3 go off. When the switch SW1 goes off (open), power supply is supplied to the transistor M1 via the resistors R1 and R2, so that the transistor M1, which is a second-stage amplifier, is heavily loaded. Thereby, the current consumption of the regulator 11 can be reduced.

When the switches SW2 and SW3 go off (open), since the transistor M3 goes off, in the third-stage amplifier, of the transistors M2 and M3, only the transistor M2 is activated. Thereby, a parasitic capacitance (parasitic capacitance value for phase compensation) in the third-stage amplifier is only the parasitic capacitance of the transistor M2 shown by the solid line, so that the total overall parasitic capacity of the third-stage amplifier can be reduced.

Although it is necessary to minimize power consumption in idle mode, since a small output current flows through the regulator 11 in the idle mode, the frequency response of the third-stage amplifier (transistors M2 and M3) worsens.

Since a negative feedback operational amplifier is formed by the third-stage amplifier, the differential amplifier AMP1, and the transistor M1, a phase margin of the negative feedback loop is not ensured due to a delay of frequency response, and oscillation may occur.

However, in the regulator 11, by allowing only the transistor M2 to operate in the third-stage amplifier, a parasitic capacitance of the amplifier can be reduced. As a result, a delay of frequency response can be eliminated, and a phase margin can be sufficiently ensured.

In idle mode, the switch SW1 of the regulators 12 and 13 goes off, and power supply is supplied via the resistors R1 and R2. Therefore, the current consumption of the regulators 12 and 13 can be reduced.

FIG. 5 is a drawing showing an example of open loop gain characteristics in the regulator 11.

In FIG. 5, the horizontal axis indicates frequencies (Hz), the vertical axis of the left indicates open loop gain (dB) of the regulator 11, and the vertical axis of the right indicates phases (deg) from output to input at open loop.

In this case, as shown in the drawing, a sufficient phase margin is ensured because a phase difference is approximately 65 deg when gain is 0 dB.

In the transistors M2 and M3, the transistor M2 is formed to be smaller in size than the transistor M3. The transistor M2 is decided so that a sufficient phase (e.g., 65 deg or more) is ensured when gain is 0 dB as shown in FIG. 5, in idle mode.

The size of the transistor M3 is decided so that a sufficient driving capability is ensured when the transistors M2 and M3 are turned on in normal mode.

With reference to FIG. 6, the following describes the operation of the regulator 11 when the semiconductor integrated circuit device 1 for RF processing is in normal mode (Normal Power).

When the semiconductor integrated circuit device 1 for RF processing is in normal mode in which RX (reception) or TX (transmission) is performed, an output current is large.

In this case, the regulator control signal Cr goes high, and all of the switches SW1 to SW3 go on as shown in the drawing. By turning the switch SW1 on, a power supply is supplied to the transistor M1 via only the resistor R2.

Since greater emphasis is placed on noise characteristics than on reduction in current consumption of the regulator 11, by supplying power supply to the transistor M1 being a second-stage amplifier via only the resistor R2, load resistance is lowered, so that noise can be reduced.

By turning the switches SW2 and SW3 on, the transistor M3 is turned on. Accordingly, in the third-stage amplifier, both the transistors M2 and M3 are activated. As a result, driving capability is increased, and stable power supply voltage VCC1 can be supplied.

Likewise, also in the regulators 12 and 13, by turning the switch SW1 on, noise can be significantly reduced.

By this construction, according to the present embodiment, the semiconductor integrated circuit device 1 for RF processing can output, in idle/normal mode, stable power supply voltage VCC1 regardless of changes in output current.

The regulators 11 to 13 can be devised to consume a small amount of power in idle mode.

Hereinbefore, although the invention made by the inventors of the present invention has been described in detail based on the preferred embodiments, it goes without saying that the present invention is not limited to the preferred embodiments, but may be modified in various ways without changing the main purports of the present invention.

The present invention is suitable to technology for stably supplying a power supply voltage in a semiconductor integrated circuit device for RF processing used for wireless communication system such as cellular phones.

What is claimed is:

1. A semiconductor integrated circuit device, comprising:
a receiving block;
a transmitting block; and
a first power supply unit that supplies a power supply voltage to the receiving block and the transmitting block, respectively,
wherein the first power supply unit includes a load element control unit that makes load resistance of the first power supply unit to be higher than the time when the receiving block and the transmitting block are operating normally, in idle mode in which functions of the receiving block and the transmitting block are inactive.

2. The semiconductor integrated circuit device according to claim 1,
wherein the first power supply unit includes an electrostatic capacity control unit that arbitrarily makes electrostatic capacity values for phase compensation variable, and
wherein when the receiving block and the transmitting block are in idle mode, the electrostatic capacity control unit makes electrostatic capacity values for phase compensation smaller than the time when the receiving block and the transmitting block are operating normally.

3. The semiconductor integrated circuit device according to claim 2,
wherein electrostatic capacity values for phase compensation made variable by the electrostatic capacity control unit are parasitic capacitance values of a final-stage output transistor, and
wherein the electrostatic capacity control unit makes electrostatic capacity values for phase compensation variable by switching the number of connections of at least two final-stage output transistors.

4. The semiconductor integrated circuit device according to claim 1, including a temperature detecting means that detects an internal temperature of the semiconductor integrated circuit device,
wherein the first power supply unit supplies a power supply voltage to the temperature detecting means.

5. A semiconductor integrated circuit device, comprising:
an oscillator block comprising circuits common to a receiving block and a transmitting block; and
a second power supply unit that supplies a power supply voltage to the oscillator block,
wherein the second power supply unit includes a load element control unit that makes load resistance of the second power supply unit higher than the time when the receiving block and the transmitting block are operating normally, in idle mode in which functions of the receiving block and the transmitting block are inactive.

6. The semiconductor integrated circuit device according to claim 1, including a third power supply unit that supplies a power supply voltage to a front end module externally connected to the semiconductor integrated circuit device,
wherein the third power supply unit includes a load element control unit that makes load resistance of the third power supply unit higher than the time when the receiving block and the transmitting block are operating normally when the receiving block and the transmitting block are in idle mode.

7. A wireless communication system including a semiconductor integrated circuit device for radio frequency processing that demodulates a receive signal and modulates a transmission signal,
wherein the semiconductor integrated circuit device comprises:
a receiving block;
a transmitting block; and
a first power supply unit that supplies a power supply voltage to the receiving block and the transmitting block, respectively,
wherein the first power supply unit includes a load element control unit that makes load resistance of the first power supply unit higher than the time when the receiving block and the transmitting block are operating normally, in idle mode in which functions of the receiving block and the transmitting block are inactive.

8. The wireless communication system according to claim 7,
wherein the first power supply unit includes an electrostatic capacity control unit that arbitrarily makes electrostatic capacity values for phase compensation variable, and
wherein when the receiving block and the transmitting block are in idle mode, the electrostatic capacity control unit makes electrostatic capacity values for phase compensation smaller than the time when the receiving block and the transmitting block are operating normally.

9. The wireless communication system according to claim 8,
wherein electrostatic capacity values for phase compensation made variable by the electrostatic capacity control unit are parasitic capacitance values of a final-stage output transistor, and
wherein the electrostatic capacity control unit makes electrostatic capacity values for phase compensation variable by switching the number of connections of at least two final-stage output transistors.

10. The wireless communication system according to claim 7, including a temperature detecting means that detects an internal temperature of the semiconductor integrated circuit device,
wherein the first power supply unit supplies a power supply voltage to the temperature detecting means.

11. A wireless communication system, comprising:
an oscillator block comprising circuits common to a receiving block and a transmitting block; and
a second power supply unit that supplies a power supply voltage to the oscillator block,
wherein the second power supply unit includes a load element control unit that makes load resistance of the second power supply unit higher than the time when the receiving block and the transmitting block are operating normally, in idle mode in which functions of the receiving block and the transmitting block are inactive.

12. The wireless communication system according to claim 7, including a front end module externally connected to the semiconductor integrated circuit device,
wherein the semiconductor integrated circuit device includes a third power supply unit that supplies a power supply voltage to the front end module, and
wherein the third power supply unit includes a load element control unit that makes load resistance of the third power supply unit higher than the time when the receiving block and the transmitting block are operating normally when the receiving block and the transmitting block are in idle mode.
